(19) United States
(12) Patent Application Publication
(10) Pub. No.: US 2009/0091241 A1
(43) Pub. Date: Apr. 9, 2009

(54) FULL-COLOR ORGANIC LIGHT-EMITTING DIODE DISPLAY PANEL AND FABRICATING METHOD THEREOF

(75) Inventors: Chung Che Tsou, Taoyuan County (TW); Cheng Fan Lin, Hsinchu County (TW); Tzeng Cheng Luo, Taipei County (TW); Shin Ju Lin, Taichung City (TW); Tzung Zone Li, Yunlin County (TW); Hai Tang, Taoyuan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RITDISPLAY CORPORATION, Hsin Chu (TW)

(21) Appl. No.: 11/862,134

(22) Filed: Sep. 26, 2007

(30) Foreign Application Priority Data
Oct. 4, 2006 (TW) 095136850
Aug. 15, 2007 (TW) 096130095

(51) Int. Cl. H01J 1/62; H01J 9/20

(52) U.S. Cl. 313/504; 445/24

(57) ABSTRACT

A full-color OLED display panel comprises a full-color organic light-emitting device and a colored filter device stacked on the light-exit surface of the full-color organic light-emitting device. The full-color organic light-emitting device comprises a first electrode, a plurality of second electrodes, a first light-emitting layer sandwiched between the first electrode and a portion of the second electrodes, and a second light-emitting layer sandwiched between the first electrode and portions of the second electrodes and the first light-emitting layer. The colored filter device comprises a substrate, and a plurality of first color filter portions, a plurality of second color filter portions and a plurality of third color filter portions disposed on the surface of the substrate. The first color filter portions allow a first color light emitted from the first light-emitting layer to pass through, and the second color filter portions and the third color filter portions each allow rays with different wavelengths in a second color light emitted from the second light-emitting layer to pass through.

### BACKGROUND OF THE INVENTION

1. Field of the Invention

The present invention relates to an organic electroluminescent display panel and a fabricating method thereof, and more particularly to a full-color OLED display panel and a fabricating method thereof.

2. Description of the Related Art

The light-emitting principle adopted by organic light-emitting display panels is different from the technology of a currently prevailing LCD panel using liquid crystal as a light switch medium. The basic structure of an OLED includes an organic fluorophor sandwiched between two layers of electrodes. The fluorophor can emit light under an appropriate voltage. Therefore, a backlight source is not needed, and the OLED display can exhibit graphs and texts with a thin structure. Moreover, in order to improve the OLED display panel and make it into an optimal display element, the research on full-color technology in recent years has become the key point. Several common methods are described as follows.

As shown in FIG. 1, the organic light-emitting display panel 10 has organic light-emitting layers 121, 122, and 123 capable of emitting red, green, and blue lights respectively, and a cathode 11 and an anode 13 sandwiching the organic light-emitting layers between them. An insulating layer 14 separates the anode 13 and the organic light-emitting layers 121, 122, and 123 into electric, independent individual parts. An OLED structure 1a constituted by the cathode 11, organic light-emitting layers 121, 122, 123, and the anode 13 is formed and stacked on a transparent substrate 15. Further, a polarizing plate 16 is disposed on the light-exit surface of the transparent substrate 15, which allows the light in a specific polarizing direction among those generated by the organic light-emitting layers 121, 122, 123 to pass through.

However, the color saturation of the organic light-emitting display panel 10 is unsatisfactory, and the ratio based on NTSC color saturation is about 66%, so a large amount of power is consumed in order to tune a full-color image. Moreover, though the polarizing plate 16 improves the contrast of the panel display, and only a portion of the lights can pass through, which reduces the overall brightness of the panel by approximately 42%, the polarizing plate 16 increases the material cost. Furthermore, high-precise masks and high-precise alignment apparatuses are used in related processes of the organic light-emitting layers 121, 122, 123 for precisely defining the corresponding coverage regions. However, during the fabricating, the materials of different light-emitting layers may be stacked with each other due to mask deformation or misalignment, thus resulting in the problem of abnormal light color mixing of the panel.

FIG. 2 is a schematic sectional view of a conventional organic light-emitting display panel. The organic light-emitting display panel 20 has an organic light-emitting layer 212 for emitting white light, and a cathode 211 and an anode 213 sandwiching the organic light-emitting layer 212 between them. An insulating layer 214 separates the anode 213 and the organic light-emitting layer 212 into a plurality of independent light-emitting layers. The aforesaid OLED structure 21 is formed and stacked on a color filter 22. The color filter 22 is formed by disposing a plurality of red filter portions 223, green filter portions 224, and blue filter portions 225 on a transparent substrate 221 (for example, glass), and using a black matrix 222 to separate the red filter portions 223, green filter portions 224, and blue filter portions 225 to avoid improper light mixing. In order to planarize the surface of the color filter 22 to facilitate the stacking of the anode 213 and the insulating layer 214, a planarization layer 226 is needed to cover the surfaces of the filter portions of the substrate 221 and the black matrix 222.

The white organic light-emitting layer 212 is usually formed by adding a complementary orange light-emitting material to a blue light-emitting material in order to exhibit white light. However, as the white-light spectrum has a wide distribution range, the light source transmittance of the white light relative to the color filter 22 is very poor (the transmittance of the red filter portions 223 is about 16%, the transmittance of the green filter portions 224 is about 53%, and the transmittance of the blue filter portions 225 is about 16%), thus attenuating the brightness. After the white light passes through the blue filter portions 225 and the green filter portions 224, the color saturation of the blue and green lights passing through is very poor, so a large amount of power consumption must be taken into consideration when tuning and designing a full-color display panel. Moreover, the NTSC color saturation is also very poor, about 60%. As the white organic light-emitting layer 212 is formed by mixing the light-emitting materials of at least two color lights, the thickness variation or the changes in material doping concentration of the organic light-emitting layer 212 may affect the distribution of the white-light spectrum, i.e., the adjustment range of the control parameters in the fabricating processes becomes narrow.

FIG. 3 is a schematic sectional view of a conventional organic light-emitting display panel. The organic light-emitting display panel 30 is a panel structure disclosed in R.O.C. Patent No. I256271, wherein the organic light-emitting layers 121 and 122 of the OLED structure 1a in FIG. 1 are replaced by orange organic light-emitting layers 311 and 312, so as to form a similar OLED structure 31. In addition, the OLED structure 31 is combined with the color filter 22 in FIG. 2. Therefore, the OLED structure 31 in FIG. 3 may have the same problems as the aforementioned organic light-emitting display panel 10, and the details will not be described herein again.

FIG. 4 is a schematic sectional view of a conventional organic light-emitting display panel. The organic light-emitting display panel 40 is a panel structure disclosed in R.O.C. Patent No. I255669, wherein organic light-emitting layers 414, 413 and 412 for generating red, green, and blue lights respectively are successively stacked on a red-light resonance layer 415, a green-light resonance layer 416, and a blue-light resonance layer 417, so as to form a white light-emitting unit 41a. A cathode 411 is disposed above an OLED structure 41, and an anode 419 opposite the cathode 411 is disposed on another end surface of the white light-emitting unit 41a. Resonance layers separated by an insulating layer 418 are used one by one to make the mixed white light generate a microcavity effect, wherein the structure and thickness of the resonance layers can be adjusted to convert the white light into red, green, and blue lights respectively. The converted color lights then pass through the color filter 22 and become red, green, and blue lights with purer chroma. In addition, the brightness proportion of each light-emitting layer can be adjusted to generate a full-color display effect.

As the thickness and structure of the red-light resonance layer 415, green-light resonance layer 416, and blue-light resonance layer 417 may affect the result of the conversion of white light into each color light, and as the variation in thickness or the changes of the material doping concentration of the red, green, and blue organic light-emitting layers 414, 413 and 412 may also affect the distribution of the white-light spectrum, the fabricating process is very difficult.

FIG. 5 is a schematic sectional view of a conventional organic light-emitting display panel. The organic light-emitting display panel 50 is a panel disclosed in R.O.C. Patent No. I249149, which includes an OLED structure 1a′ and a color filter 22. The organic light-emitting display panel 10 in the OLED structure 1a′ is different from that of the OLED structure 1a in terms of having a semipermeable membrane 124, which is respectively disposed between the anode 13 and the organic light-emitting layers 121, 122, 123. The semipermeable membrane 124 and the opposite cathode 11 sandwich the organic light-emitting layers 121, 122 and 123 between them in order to form a microcavity structure, so that the thickness of each organic light-emitting layer can be adjusted to facilitate the generation of lights with specific wavelengths. Then, the generated lights pass through the color filter 22 to become purer red, green, and blue lights.

As it is similar to the OLED structure 1a in FIG. 1, the OLED structure 1a′ has the same problems as the aforementioned organic light-emitting display panel 10, and the details will not be described herein again. Moreover, though the semipermeable membrane 124 can enhance the intensity of lights with specific wavelengths, the thickness and structure of the semipermeable membrane 124 are hard to control, thus increasing the difficulty of the fabricating process.

FIGS. 6(a)-6(b) are schematic sectional views of conventional organic light-emitting display panels. The organic light-emitting display panels 60 and 60′ are panels disclosed in R.O.C. Patent No. I272865, and respectively include an organic light-emitting layer 612 for generating a blue light and an organic light-emitting layer 612′ for generating a blue-green light in an OLED, and a cathode 611 and an anode 613 sandwiching the organic light-emitting layer 612 or 612′ between them. The insulation layer 614 divides the anode 613 and the organic light-emitting layer 612 or 612′ into a plurality of divided lighting areas. The aforesaid OLED structure 61 is formed and stacked on a color filter 62, as shown in FIG. 6(a). Similarly, the aforesaid OLED structure 61′ is formed and stacked on a color filter 62′, as shown in FIG. 6(b). The color filter 62 is formed by disposing a plurality of red filter portions 623, green filter portions 624, and blue filter portions 625 on a transparent substrate 621 (for example, glass), and using a black matrix 622 to separate the red filter portions 623, green filter portions 624, and blue filter portions 625 to avoid improper light mixing. In order to planarize the surface of the color filter 62 to facilitate the stacking of the anode 613 and the insulating layer 614, a planarization layer 626 is needed to cover the surfaces of the filter portions of the substrate 621 and the black matrix 622.

As shown in FIG. 6(a), the blue lights emitted by the organic light-emitting layer 612 need to be transferred into red lights first by a first color-changing medium (CCM) layer 627. Afterwards, the converted light enters the red filter portions 623 and moderately pure red lights are obtained. Similarly, green lights are emitted by a second color-changing medium 628 before lights enter the green filter portions 624.

As shown in FIG. 6(b), the blue-green lights emitted by the organic light-emitting layer 612′ need to be transferred into red lights first by the first color-changing medium layer 627. Afterwards, the converted light enters the red filter portions 623 and moderately pure red lights are obtained. Color-changing medium layers are not used, because pure green lights and pure red lights can be obtained by filtering the blue-green lights through the green filter portions 624 and blue filter portions 625. As to each of the embodiments in FIGS. 6(a)-6(b), at least one kind of colored filter portion needs to be combined with a color-changing medium layer. Therefore, brightness ratios are limited by the color-changing rates of the color-changing medium, and the manufacture of such a light-emitting display panel is more difficult, so the cost goes up.

In view of the above, some of the conventional full-color OLED display panels cannot achieve red, green, and blue lights of preferred chroma and brightness, some are unstable in specifications and characteristics due to process variations and are difficult to control, and some have extremely complicated processes because the process window of the process parameters is too narrow. Therefore, the present invention provides a full-color OLED display panel with preferred optical characteristics and a simple fabricating process and a fabricating method thereof, so as to solve the problems in the conventional art.

### SUMMARY OF THE INVENTION

The present invention is directed to providing an OLED display panel and a fabricating method thereof, wherein the OLED structure generates red, green and blue lights with purer chroma, and the color filter allows red, green and blue lights with a preferred color saturation to pass through.

The present invention is also directed to providing an OLED display panel with a simple fabricating process and a fabricating method thereof, wherein a wide-open mask is adopted instead of a high-precise mask, and the fine optical characteristics of the OLED display panel are still maintained.

In order to achieve the above objectives, the present invention provides a full-color OLED display panel and a fabricating method thereof. The display panel comprises a full-color organic light-emitting device and a colored filter device stacked on the light-exit surface of the full-color organic light-emitting device. The full-color organic light-emitting device comprises a first electrode, a plurality of second electrodes, a first light-emitting layer sandwiched between the first electrode and a portion of the second electrodes, a second light-emitting layer sandwiched between the first electrode and a portion of the second electrodes, and a third light-emitting layer sandwiched between the first electrode and a portion of the second electrodes. The colored filter device comprises a substrate, and a plurality of first color filter portions and a plurality of second color filter portions disposed on the surface of the substrate. The first color filter portions allow a first color light emitted from the first light-emitting layer to pass through, and the second color filter portions allow a second color light emitted from the second light-emitting layer to pass through. The third light-emitting layer is further stacked on the surfaces of the first light-emitting layer and the second light-emitting layer. The colored filter device further comprises a plurality of third color filter portions, which allow a third color light emitted from the third light-emitting layer to pass through.

The present invention provides a full-color OLED display panel and a fabricating method thereof. The display panel comprises a full-color organic light-emitting device and a colored filter device stacked on the light-exit surface of the full-color organic light-emitting device. The full-color organic light-emitting device comprises a first electrode, a plurality of second electrodes, a first light-emitting layer sandwiched between the first electrode and a portion of the second electrodes, and a second light-emitting layer sandwiched between the first electrode and portions of the second electrodes and the first light-emitting layer. The colored filter device comprises a substrate, and a plurality of first color filter portions, a plurality of second color filter portions and a plurality of third color filter portions disposed on the surface of the substrate. The first color filter portions allow a first color light emitted from the first light-emitting layer to pass through, and the second color filter portions and the third color filter portions each allow rays with different wavelengths in a second color light emitted from the second light-emitting layer to pass through.

The fabricating method of a full-color OLED display panel has the following steps. First, a colored filter device is provided. Then, a plurality of second electrodes and an insulating layer for separating the plurality of second electrodes are formed on the colored filter device. Next, a first light-emitting layer is deposited on a first electrode assembly in the plurality of second electrodes, a second light-emitting layer is deposited on a second electrode assembly in the plurality of second electrodes, and a third light-emitting layer is deposited on the first light-emitting layer, the second light-emitting layer, and a third electrode assembly in the plurality of second electrodes. Afterwards, a first electrode is formed on the third light-emitting layer.

The fabricating method of a full-color OLED display panel has the following steps. First, a colored filter device is provided. Then, a plurality of second electrodes and an insulating layer for separating the plurality of second electrodes are formed on the colored filter device. Next, a first light-emitting layer is deposited on a first electrode assembly in the plurality of second electrodes, and a second light-emitting layer is deposited on a second electrode assembly and a third electrode assembly in the plurality of second electrodes. Afterwards, a first electrode is formed on the second light-emitting layer.

### BRIEF DESCRIPTION OF THE DRAWINGS

The invention will be described according to the appended drawings in which:

FIG. 1 is a schematic sectional view of a conventional organic light-emitting display panel;

FIG. 2 is a schematic sectional view of a conventional organic light-emitting display panel;

FIG. 3 is a schematic sectional view of a conventional organic light-emitting display panel;

FIG. 4 is a schematic sectional view of a conventional organic light-emitting display panel;

FIG. 5 is a schematic sectional view of a conventional organic light-emitting display panel;

FIGS. 6(a)-6(b) are schematic sectional views of a full-color OLED display panel of the present invention;

FIG. 7 is a schematic sectional view of a full-color OLED display panel according to another embodiment of the present invention;

FIGS. 8(a)-8(f) are schematic views of the fabricating process of the full-color OLED display panel according to the present invention;

FIG. 9 is a schematic sectional view of a full-color OLED display panel according to another embodiment of the present invention;

FIG. 10 is a schematic sectional view of a full-color OLED display panel according to a further embodiment of the present invention;

FIG. 11 is a schematic sectional view of a full-color OLED display panel according to a further embodiment of the present invention;

FIG. 12 is a schematic sectional view of a full-color OLED display panel according to a further embodiment of the present invention; and

FIG. 13 is a schematic sectional view of a full-color OLED display panel according to a further embodiment of the present invention.

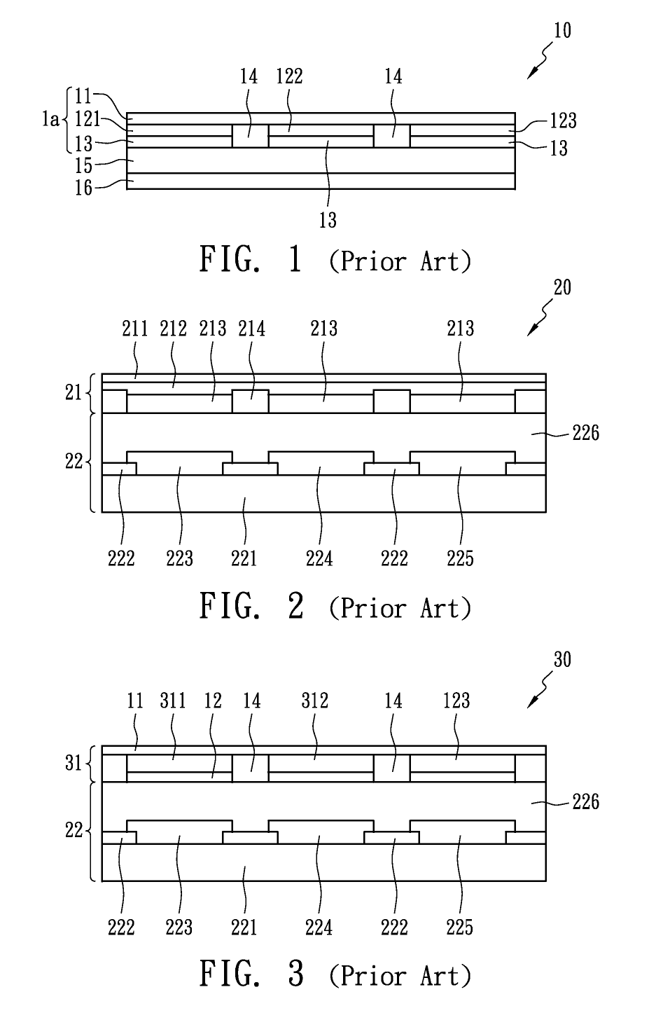

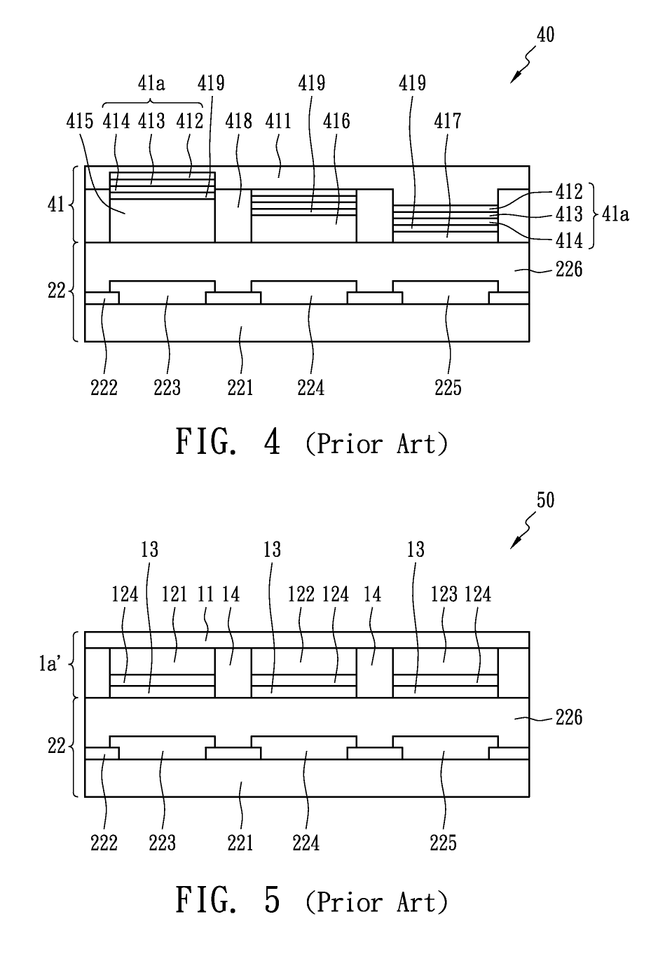

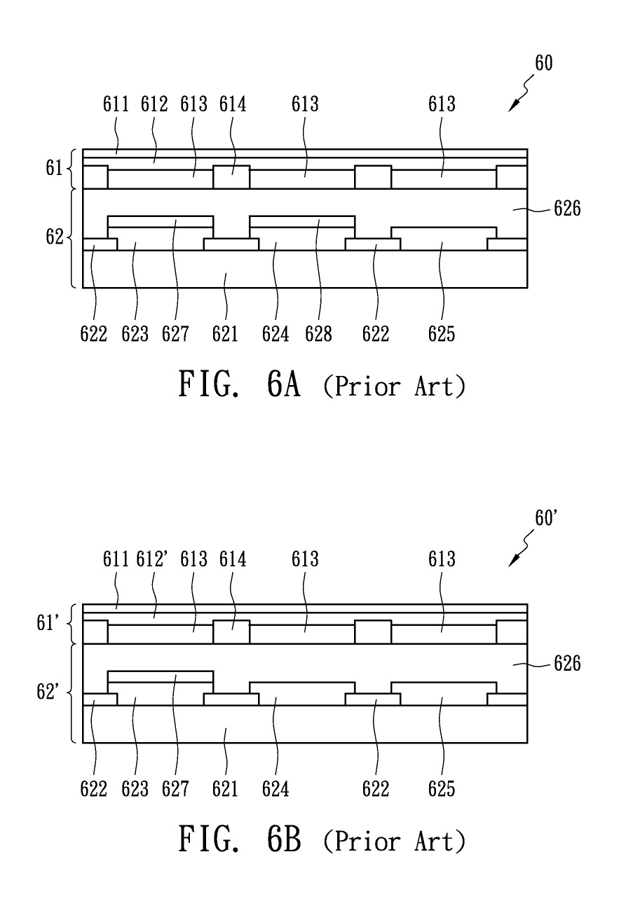

### PREFERRED EMBODIMENT OF THE PRESENT INVENTION

The accompanying drawings are included to provide a further understanding of the invention, and to explain the technical features of the invention clearly.

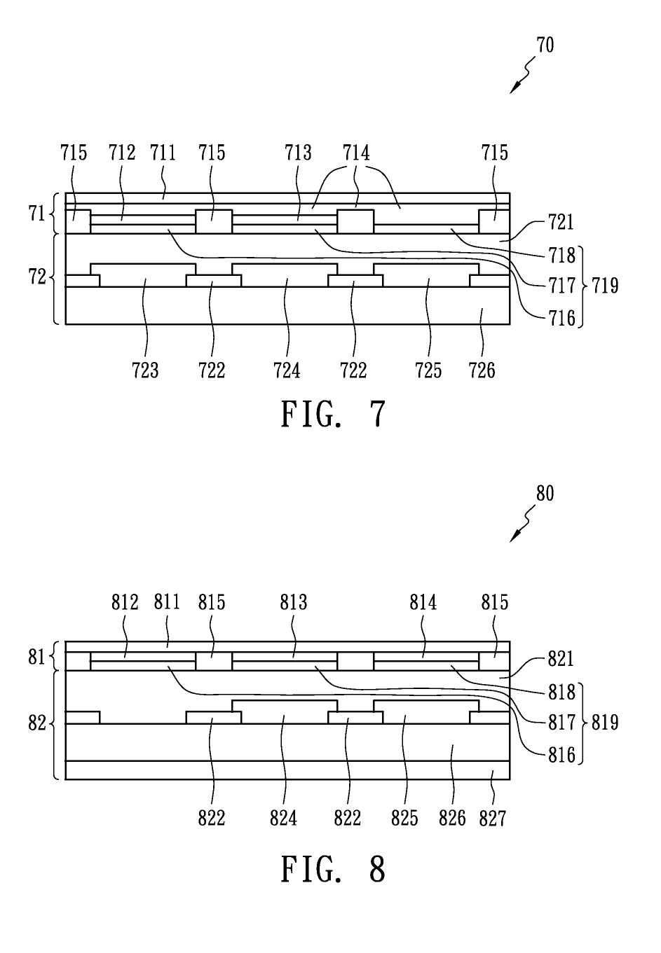

FIG. 7 is a schematic sectional view of a full-color OLED display panel of the present invention, in which only three sub-pixels of one pixel in the display panel are shown. The full-color OLED display panel 70 includes a full-color organic light-emitting device 71 and a colored filter device 72 stacked on the light-exit surface of the full-color organic light-emitting device 71. The full-color organic light-emitting device 71 includes a first electrode 711, a plurality of second electrodes 719, a first light-emitting layer 712 sandwiched between the first electrode 711 and a first electrode assembly 716 in the second electrodes 719, a second light-emitting layer 713 sandwiched between the first electrode 711 and a second electrode assembly 717 in the second electrodes 719, and a third light-emitting layer 714 sandwiched between the first electrode 711 and a third electrode assembly 718 in the second electrodes 719. If the polarity of the first electrode 711 is cathode, the polarity of each second electrode 719 is anode, and thus, the full-color organic light-emitting device 71 is a bottom-emission type. Otherwise, the full-color organic light-emitting device 71 is a top-emission type. The first light-emitting layer 712, second light-emitting layer 713, and third light-emitting layer 714 respectively emit lights of a first color light (red), a second color light (green), and a third color light (blue) after being electrically excited. Further, an insulating layer 715 separates the second electrodes 719 into the first electrode assembly 716, the second electrode assembly 717, and the third electrode assembly 718, and also separates the first light-emitting layer 712, the second light-emitting layer 713, and the third light-emitting layer 714. However, being defined by a wide-open mask, the third light-emitting layer 714 covers the surfaces of the first light-emitting layer 712, the second light-emitting layer 713, and the insulating layer 715, so as to substitute a high-precise mask, thereby obtaining the advantages of reducing the cost, increasing the output in unit time, and improving the yield. Though the third light-emitting layer 714 covers the surfaces of the first light-emitting layer 712 and the second light-emitting layer 713, a light-emitting material of a wider energy gap can be selected as the third light-emitting layer 714, thus making the covered portions emit fewer lights. In another aspect, the filter portions of the colored filter device 72 corresponding to the positions of the first light-emitting layer 712 and the second light-emitting layer 713 can also filter the third color light.

The colored filter device 72 includes a substrate 726, and a plurality of first color filter portions 723, a plurality of second color filter portions 724, and a plurality of third color filter portions 725 disposed on the surface of the substrate 726. The first color filter portions 723 allow a first color light (for example, red) emitted from the first light-emitting layer 712 to pass through. The second color filter portions 724 allow a second color light (for example, green) emitted from the second light-emitting layer 713 to pass through. The third color filter portions 725 allow a third color light (for example, blue) emitted from the third light-emitting layer 714 to pass through. The first color filter portions 723, the second color filter portions 724, and the third color filter portions 725 are separated by a black matrix 722, so as to avoid improper light mixing. In order to planarize the surface of the colored filter device 72 to facilitate the stacking of the second electrodes 719 and the insulating layer 615, a planarization layer 721 is needed to cover the surfaces of the filter portions of the substrate 726 and the black matrix 722.

The full-color OLED display panel 70 has the following advantages.

1. The first light-emitting layer 712, second light-emitting layer 713, and third light-emitting layer 714 can emit light individually, so the frequency spectrums of various emitted color lights are narrow. Compared with the white light emitted from the conventional white organic light-emitting unit, the light transmittance of various color lights of the present invention after passing through the filter portions is superior, and thus the luminance performance thereof can be greatly improved.

2. Each color light is filtered by the colored filter device 72, thus having a better color saturation. As such, while tuning the full-color image, the light utilization is improved, thus saving power and obtaining the NTSC color saturation of above 100%.

3. As the colored filter device 72 has the black matrix 722 and various filter portions, the contrast of various color lights can be improved without attaching an additional polarizing plate, thus saving costs.

4. Even if the materials of two different light-emitting layers partially overlap each other due to mask deformation or misalignment, as the light transmittance of the filter portions of a specific color light to the other two color lights is low, the abnormal color mixing of the panel can be effectively alleviated.

5. A wide-open mask is used instead of a high-precision mask when a light-emitting layer of a color light is formed, thus saving costs, increasing the output, and improving the yield.

FIG. 8 is a schematic sectional view of a full-color OLED display panel according to another embodiment of the present invention. The full-color OLED display panel 80 includes a full-color organic light-emitting device 81 and a colored filter device 82 stacked on the light-exit surface of the full-color organic light-emitting device 81. The full-color organic light-emitting device 81 includes a first electrode 811, a plurality of second electrodes 819, a first light-emitting layer 812 sandwiched between the first electrode 811 and a first electrode assembly 816 in the second electrodes 819, a second light-emitting layer 813 sandwiched between the first electrode 811 and a second electrode assembly 817 in the second electrodes 819, and a third light-emitting layer 814 sandwiched between the first electrode 811 and a third electrode assembly 818 in the second electrodes 819. If the polarity of the first electrode 811 is cathode, the polarity of the second electrodes 819 is anode, and thus the full-color organic light-emitting device 81 is a bottom-emission type. Otherwise, the full-color organic light-emitting device 81 is a top-emission type. The first light-emitting layer 812, second light-emitting layer 813, and third light-emitting layer 814 respectively emit lights of a first color light (red), a second color light (green), and a third color light (blue) after being electrically excited. Further, an insulating layer 815 separates the second electrodes 819 into the first electrode assembly 816, the second electrode assembly 817, and the third electrode assembly 818, and also separates the first light-emitting layer 812, the second light-emitting layer 813, and the third light-emitting layer 814.

The colored filter device 82 includes a substrate 826 and a plurality of second color filter portions 824 and third color filter portions 825 disposed on the surface of the substrate 826. The second color filter portions 824 allow a second color light (for example, green) emitted from the second light-emitting layer 813 to pass through. The third color filter portions 825 allow a third color light (for example, blue) emitted from the third light-emitting layer 814 to pass through. If the first light-emitting layer 812 emits a red light, due to the preferred color saturation of the red light, the first color filter portions that allow the red light to pass through will not need to be used. The second color filter portions 824 and the third color filter portions 825 are separated by a black matrix 822, so as to avoid improper light mixing. In order to planarize the surface of the colored filter device 82 to facilitate the stacking or forming of the second electrodes 819 and the insulating layer 815, a planarization layer 821 is needed to cover the surface opposite the substrate 826. Further, a polarizing plate 827 is attached to the substrate 826 in order to improve the contrast.

The full-color OLED display panel 80 has the following advantages.

1. As the colored filter device 82 does not need the first color filter portions which allow the red light to pass through, the light transmittance of the red light after passing through the colored filter device 82 is superior, thus improving the light utilization and reducing the process of fabricating the first color filter portions.

2. As the color saturation of each color light is preferable, while tuning the full-color image, the light utilization is improved, thus saving power and obtaining the NTSC color saturation of above 100%.

3. Even if the materials of two different light-emitting layers partially overlap each other due to mask deformation or misalignment, as the light transmittance of the filter portions of a specific color light to the other two color lights is low, the abnormal color mixing of the panel can be effectively alleviated.

4. Further, a polarizing plate 827 is attached to the substrate 826 in order to improve the contrast.

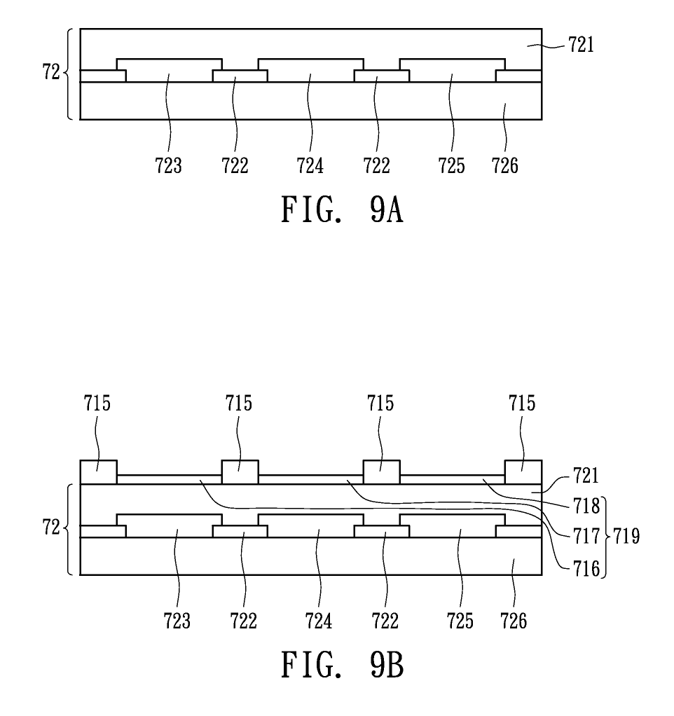

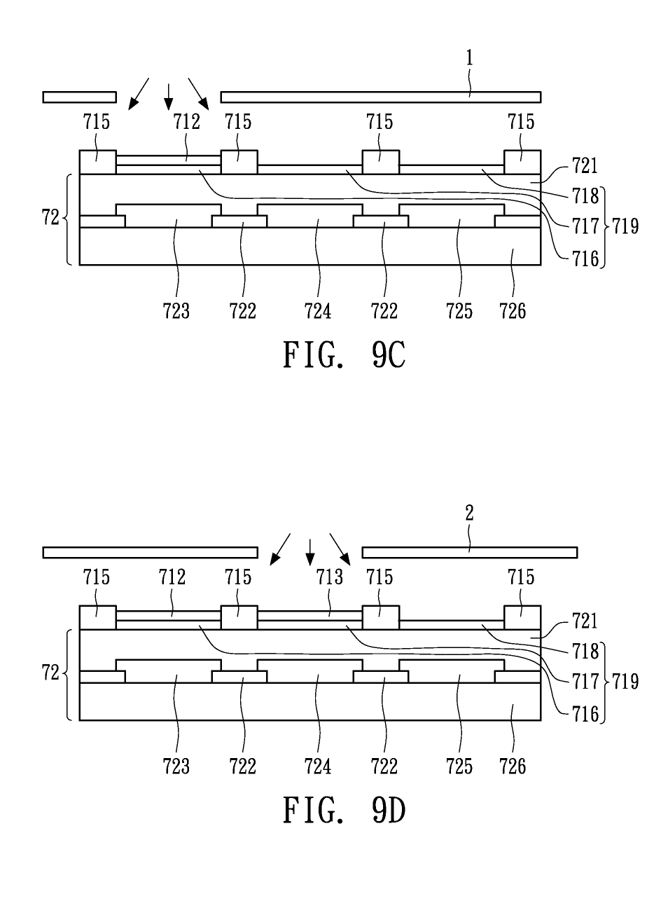

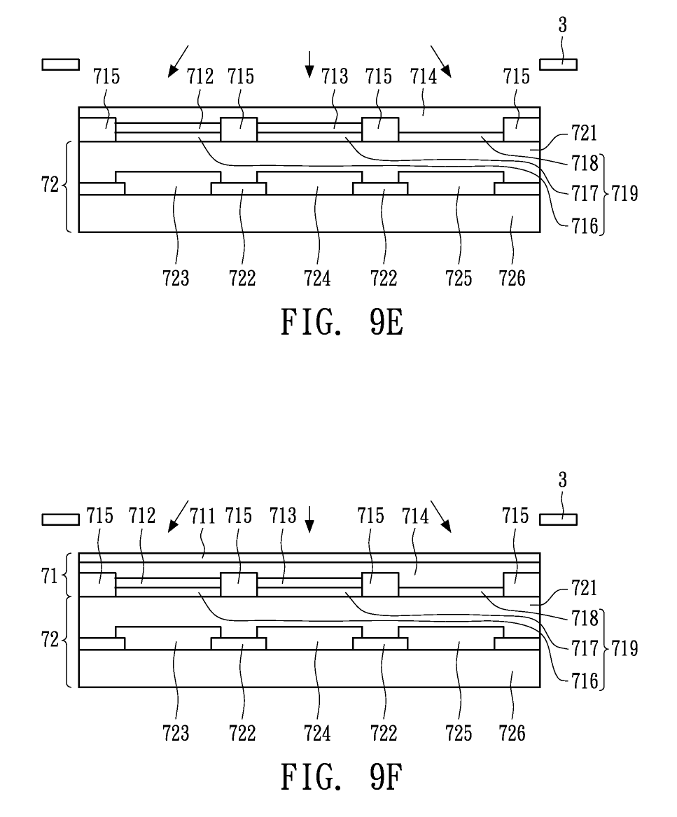

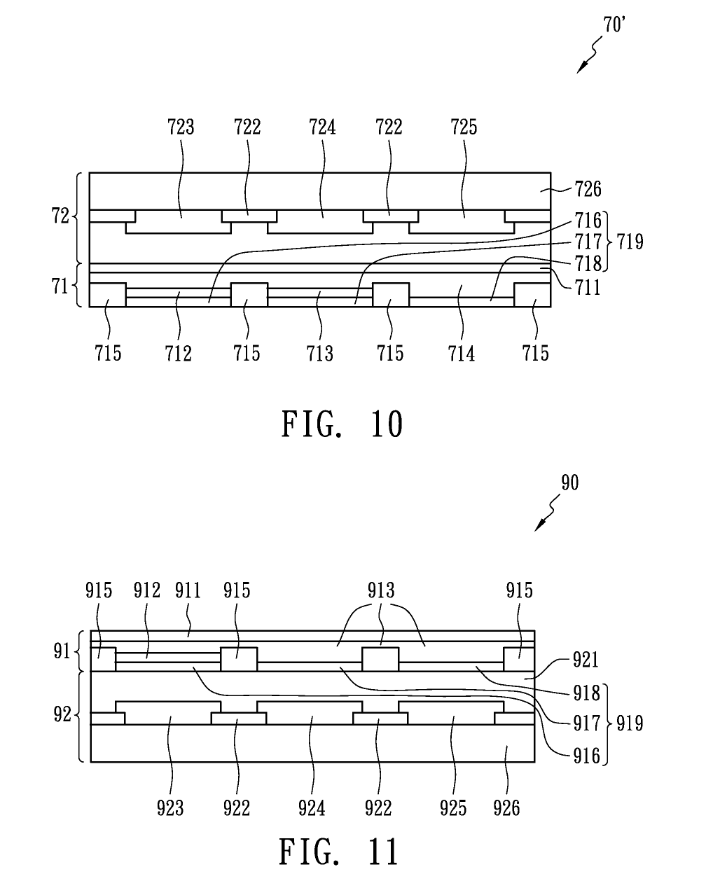

FIGS. 9(a)-9(f) are schematic views of the fabricating process of the full-color OLED display panel according to the present invention. Referring to FIG. 9(a), a colored filter device 72 is first provided. Next, the patterns of the insulating layer 715 and the second electrodes 719 are defined through a lithographic process, i.e., forming the second electrodes 719 and the insulating layer 715 that separates the second electrodes 719 on the colored filter device 72, as shown in FIG. 9(b). Then, a high-precise mask 1 is used to define the first light-emitting layer 712 which is deposited (for example, by evaporation) on the first electrode assembly 716 in the second electrodes 719, as shown in FIG. 9(c). A high-precise mask 2 is further used to define the second light-emitting layer 713 which is deposited (for example, by evaporation) on the second electrode assembly 717 in the second electrodes 719, as shown in FIG. 9(d). Afterwards, a wide-open mask 3 is used to define the third light-emitting layer 714 which is deposited (for example, by evaporation) on the first light-emitting layer 712, the second light-emitting layer 713, and the third electrode assembly 718 in the second electrodes 719, as shown in FIG. 9(e). Finally, the wide-open mask 3 is used to define the first electrode 711 which is deposited (for example, by evaporation) on the third light-emitting layer, as shown in FIG. 9(f).

The above embodiments can be applied in an active or passive OLED display panel, and a top- or bottom-emission type OLED display panel. FIG. 10 is a schematic sectional view of a full-color OLED display panel according to another embodiment of the present invention. The full-color OLED display panel 70′ is of an inverse type, wherein the first electrode 711 was previously formed on the surface of the colored filter device 72, while in FIG. 7, the second electrode 719 was previously formed on the surface of the full-color organic light-emitting device 72.

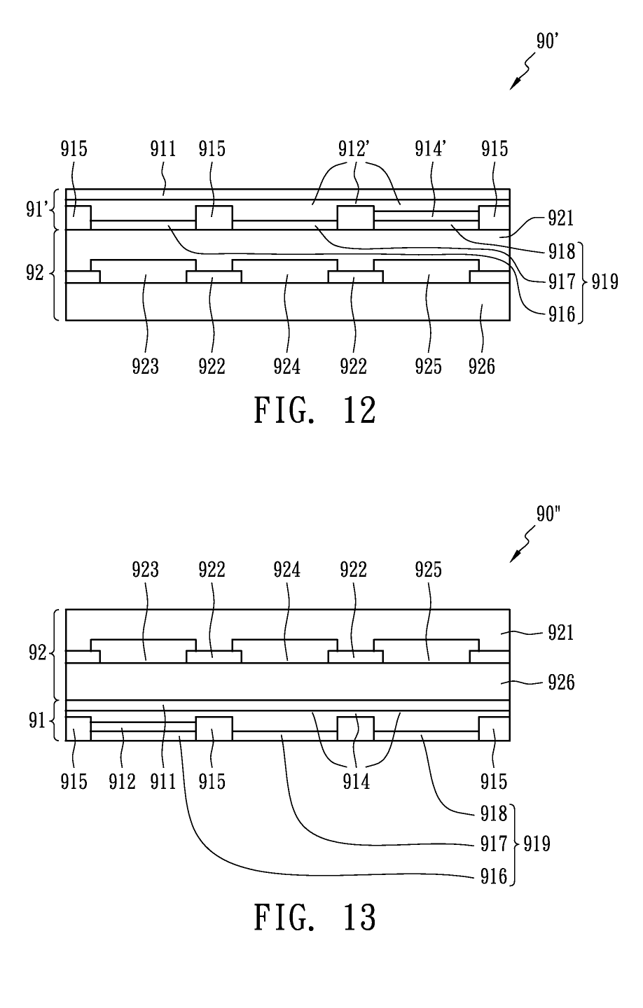

FIG. 11 is a schematic sectional view of a full-color OLED display panel according to a further embodiment of the present invention. This figure merely shows three sub-pixels of a pixel in a partial display panel. A full-color OLED display panel 90 comprises a full-color organic light-emitting device 91 and a colored filter device 92 stacked on the light-exit surface of the full-color organic light-emitting device 91. The full-color organic light-emitting device 91 comprises a first electrode 911, a plurality of second electrodes 919, a first light-emitting layer 912 sandwiched between the first electrode 911 and a first electrode assembly 916 of the second electrodes 919, and a second light-emitting layer 913 sandwiched between the first electrode 911 and a second electrode assembly 917 and a third electrode assembly 918 of the second electrodes 919. When the polarity of the first electrode 911 is negative and the polarity of the second electrodes 919 is positive, the full-color organic light-emitting device 91 is a bottom-emission type. By contrast, when the polarity of the first electrode 911 is positive and the polarity of the second electrodes 919 is negative, the full-color organic light-emitting device 91 is a top-emission type.

The first light-emitting layer 912 and second light-emitting layer 913 each emit lights of a first color light (red) and a second color light (blue-green) after being electrically excited. Further, an insulating layer 915 separates the second electrodes 919 into the first electrode assembly 916, the second electrode assembly 917, and the third electrode assembly 918, and also separates the first light-emitting layer 912 and the second light-emitting layer 913. Though the first light-emitting layer 912 is defined by a high-precise mask, the second light-emitting layer 913 defined by a wide-open mask can overlay the first light-emitting layer 912 and the insulating layer 915. Therefore, the number of the high-precise masks can be reduced to a minimum so as to save costs, increase output per a time unit and improve production yield. Though the second light-emitting layer 913 is overlaid on the first light-emitting layer 912, the first color filter portions 723 of the colored filter device 72 corresponding to the first light-emitting layer 912 can filter the second light.

The colored filter device 92 includes a substrate 926, and a plurality of first color filter portions 923 disposed on the surface of the substrate 926, a plurality of second color filter portions 924, and a plurality of third color filter portions 725. The first color filter portions 923 allow a first color light emitted from the first light-emitting layer 912 to pass through. The second color filter portions 924 allow a portion of a second color light with specified wavelengths (for example, green) emitted from the second light-emitting layer 913 to pass through. The third color filter portions 725 allow another portion of a second color light with specified wavelengths (for example, blue) emitted from the second light-emitting layer 913 to pass through. The first color filter portions 923, the second color filter portions 924, and the third color filter portions 925 are separated by a black matrix 922, so as to avoid improper light mixing. In order to planarize the surface of the colored filter device 92 to facilitate the stacking of the second electrodes 919 and the insulating layer 915, a planarization layer 921 is needed to cover the surfaces of the filter portions of the substrate 926 and the black matrix 922. The second light-emitting layer 913 can be a single blue-green organic light-emitting layer or a stacked assembly of a blue organic light-emitting layer and a green organic light-emitting layer.

FIG. 12 is a schematic sectional view of a full-color OLED display panel according to a further embodiment of the present invention. In comparison with the full-color OLED display panel 90 in FIG. 11, the full-color organic light-emitting device 91′ of the full-color OLED display panel 90′ is modified. The full-color organic light-emitting device 91′ comprises a first electrode 911, a plurality of second electrodes 919, a first light-emitting layer 912′ sandwiched between the first electrode 911 and a first electrode assembly 916 and a second electrode assembly 917 of the second electrodes 919, and a third light-emitting layer 914 sandwiched between the first electrode 911 and a third electrode assembly 917 of the second electrodes 919.

The first color filter portions 923 allow a portion (red) of a first color light with specified wavelengths (orange) emitted from the first light-emitting layer 912′ to pass through. The second color filter portions 924 allow a portion of a second color light with specified wavelengths (green) emitted from the first light-emitting layer 912′ to pass through. The third color filter portions 925 allow a third color light (for example, blue) emitted from the third light-emitting layer 914′ to pass through. The first light-emitting layer 912′ can be a single orange organic light-emitting layer or a stacked assembly of a red organic light-emitting layer and a green organic light-emitting layer.

Furthermore, FIG. 13 is a schematic sectional view of a full-color OLED display panel according to a further embodiment of the present invention. Compared with the display panel 90, the full-color OLED display panel 90″ is an inverse type. That is, the first electrode 911 was previously formed on the colored filter device 92. In contrast, the second electrodes 919 were previously formed on the colored filter device 92.

The aforementioned descriptions of the present invention are intended to be illustrative only. Numerous alternative methods may be devised by persons skilled in the art without departing from the scope of the following claims.

What is claimed is:

1. A full-color organic light-emitting diode (OLED) display panel, comprising:
a full-color organic light-emitting device, comprising:
a first electrode;
a plurality of second electrodes;
a first light-emitting layer sandwiched between the first electrode and a first portion of the second electrodes, and emitting a first color light;
a second light-emitting layer sandwiched between the first electrode and a second portion of the second electrodes, and emitting a second color light; and
a third light-emitting layer sandwiched between the first electrode and a third portion of the second electrodes, and emitting a third color light; and
a colored filter device stacked on the light-exit surface of the full-color organic light-emitting device, comprising:
a substrate;
a plurality of first color filter portions disposed on the substrate, and allowing the first color light to pass through; and
a plurality of second color filter portions disposed on the substrate, and allowing the second color light to pass through.

2. The full-color OLED display panel as claimed in claim 1, wherein the third light-emitting layer is further stacked on the first light-emitting layer and the second light-emitting layer.

3. The full-color OLED display panel as claimed in claim 1, further comprising a plurality of third color filter portions disposed on the substrate and allowing the third color light to pass through.

4. The full-color OLED display panel as claimed in claim 1, wherein the full-color organic light-emitting device further comprises an insulating layer used for separating the second electrodes into a first electrode assembly, a second electrode assembly, and a third electrode assembly which correspond to the first portion, the second portion, and the third portion respectively.

5. The full-color OLED display panel as claimed in claim 4, wherein the first light-emitting layer is sandwiched between the first electrode and the first electrode assembly, the second light-emitting layer is sandwiched between the first electrode and the second electrode assembly, and the third light-emitting layer is sandwiched between the first electrode and the third electrode assembly.

6. The full-color OLED display panel as claimed in claim 4, wherein the insulating layer separates the first light-emitting layer and the second light-emitting layer.

7. The full-color OLED display panel as claimed in claim 4, wherein the insulating layer separates the first light-emitting layer, the second light-emitting layer, and the third light-emitting layer.

8. The full-color OLED display panel as claimed in claim 1, wherein the first light-emitting layer, the second light-emitting layer, and the third light-emitting layer respectively emit a red, green, and blue light.

9. A method for fabricating the full-color OLED display panel, comprising:
providing a colored filter device;
forming a plurality of second electrodes and an insulating layer that separates the plurality of second electrodes on the colored filter device;
depositing a first light-emitting layer on the first electrode assembly in the plurality of second electrodes;
depositing a second light-emitting layer on the second electrode assembly in the plurality of second electrodes;
depositing a third light-emitting layer on the first light-emitting layer, the second light-emitting layer, and the third electrode assembly in the plurality of second electrodes; and
forming a first electrode on the third light-emitting layer.

10. The method for fabricating the full-color OLED display panel as claimed in claim 9, wherein the third light-emitting layer is defined by a wide-open mask.

11. The method for fabricating the full-color OLED display panel as claimed in claim 10, wherein the first electrode is defined by the wide-open mask.

12. A full-color organic light-emitting diode (OLED) display panel, comprising:
a full-color organic light-emitting device, comprising:
a first electrode;
a plurality of second electrodes;
a first light-emitting layer sandwiched between the first electrode and a first portion of the second electrodes, and emitting a first color light; and
a second light-emitting layer sandwiched between the first electrode and a second portion and a third portion of the second electrodes, and emitting a second color light;
a colored filter device stacked on the light-exit surface of the full-color organic light-emitting device, comprising:
a substrate;
a plurality of first color filter portions disposed on the substrate and allowing the first color light to pass through;
a plurality of second color filter portions disposed on the substrate and allowing a portion of the second color light to pass through; and
a plurality of third color filter portions disposed on the substrate and allowing another portion of the second color light to pass through.

13. The full-color OLED display panel as claimed in claim 12, wherein the second light-emitting layer is disposed between the first light-emitting layer and the first electrode.

14. The full-color OLED display panel as claimed in claim 12, wherein the full-color organic light-emitting device further comprises an insulating layer used for separating the second electrodes into a first electrode assembly, a second electrode assembly, and a third electrode assembly which correspond to the first portion, the second portion, and the third portion respectively.

15. The full-color OLED display panel as claimed in claim 12, wherein the polarity of the first electrode is either cathode or anode, and the polarity of the second electrodes is opposite that of the first electrode.

16. The full-color OLED display panel as claimed in claim 12, wherein the first light-emitting layer emits red lights and the second light-emitting layer emits blue-green lights.

17. The full-color OLED display panel as claimed in claim 12, wherein the first light-emitting layer emits blue lights and the second light-emitting layer emits orange lights.

18. A method for fabricating the full-color OLED display panel, comprising:
providing a colored filter device;
forming a plurality of second electrodes and an insulating layer that separates the plurality of second electrodes on the colored filter device;
depositing a first light-emitting layer on the first electrode assembly in the plurality of second electrodes;
depositing a second light-emitting layer on the second electrode assembly and the third electrode assembly in the plurality of second electrodes; and
forming a first electrode on the third light-emitting layer.

19. The method for fabricating the full-color OLED display panel as claimed in claim 18, wherein the second light-emitting layer is defined by a wide-open mask.

20. The method for fabricating the full-color OLED display panel as claimed in claim 18, wherein the first electrode is defined by the wide-open mask.
